(19) United States
(12) Patent Application Publication
(10) Pub. No.: US 2016/0121431 A1
(43) Pub. Date: May 5, 2016

(54) SILVER-COMPOSITE SINTERING PASTES FOR LOW-TEMPERATURE SINTERING-BONDING

(71) Applicant: Robert Bosch GmbH, Stuttgart (DE)

(72) Inventors: Bernd HOHENBERGER, Wendlingen (DE); Steffen ORSO, Reutlingen (DE); Andrea FEIOCK, Pliezhausen (DE)

(21) Appl. No.: 14/890,136

(22) PCT Filed: Apr. 9, 2014
(86) PCT No.: PCT/EP2014/057129

§ 371 Date: Nov. 9, 2015

(30) Foreign Application Priority Data
May 7, 2013 (DE) 10 2013 208 387.4

(51) Int. Cl. B23K 35/02; B23K 1/00; B23K 35/362; B23K 35/30

(52) U.S. Cl. CPC B23K 35/025; B23K 35/3006; B23K 1/0016; B23K 35/362

(57) ABSTRACT

The present invention relates to a liquid-phase sintering composition containing low-molecular organic auxiliary agents, at least one silver salt, silver particles and one further metal solid material, characterized in that the further solid material is particulate and comprises tin.

### BACKGROUND OF THE INVENTION

The invention relates to a liquid-phase sintering composition containing low molecular weight organic auxiliaries, at least one silver salt, silver particles and a further solid metal material.

Modern power electronics are used in many fields of technology and are subject to ever-greater quality requirements in these applications. In particular, the requirements to be failsafe and for service life of the elements have increased significantly in recent years. If it is furthermore taken into account that the required current strengths in some applications are moving to ever-greater ranges, then there is a particular thermal load situation of the components. This is critical in particular when the use of high current strengths causes significant intrinsic heating of the components and there are furthermore other unfavorable environmental conditions, for example due to varying temperatures in the component environment. Control devices in the automobile sector, which are arranged directly in the engine or passenger compartment, may be mentioned here by way of example. These control devices are exposed to a constant temperature variation, which can amount to a temperature difference of up to 200° C. at the component. These stresses must be taken into account when selecting the technique for joining the components.

A greater thermal flexibility is furthermore also desired in the design and structure of MultiChip Power Packages (MCPPs), the power semiconductors currently being soldered directly onto Cu leadframes or Cu heat sinks. The lead-free solders used typically have a melting point in the range of 220-260° C., which overall restricts the working temperature of the solder compound. The use of higher temperatures (T_{Junction}) would be desirable here in order to increase the efficiency of the components.

These circumstances lead to the design requirements that the electronic components and their junctions with one another (or respectively a carrier substrate) must be thermally configured securely against loading and failure. Conventionally, connection of the electronic components is carried out using a connecting layer. Solder compounds are known as such a connecting layer, for example lead-free solder compounds of tin-silver or tin-silver-copper. At higher working temperatures, solder compounds containing lead may be used. However, solder compounds containing lead are greatly restricted in terms of their permissible technical applications by statutory regulations for reasons of environmental protection. As an alternative, lead-free hard solders are available for use at elevated or high temperatures, in particular above 200° C. Lead-free hard solders generally have a melting point higher than 200° C.

Another way of achieving higher working temperatures in the field of power electronics is offered by the use of silver sintering compounds. These silver sintering compounds can be used to join electronic components, and they theoretically achieve a working temperature of up to the melting point of silver (961.8° C.). These compounds are distinguished by their high electrical and thermal conductivity, and they make it possible that electronic components can be operated at higher temperatures, since the compounds do not melt and at the same time dissipate more heat from the system.

A disadvantage with pure silver sintering compounds is, however, that very high sintering temperatures and/or sintering pressures are required in order to sinter the junction densely, and the material costs are significantly higher than for other joining techniques. These factors increase the process costs and therefore naturally impact on the component costs.

One possible technical solution is provided, for example, by U.S. 2008 0073776 A1. This document describes a heat-dissipating composition for microelectronic components, which comprises a microelectronic component, a heat distributor and a thermal interface material (TIM) which connects the microelectronic component and the heat distributor, the TIM comprising a sintered metal nanopaste.

Another document WO 2009 012450 A1, on the other hand, describes a method for fastening a semiconductor component on a substrate by means of a sintering paste which comprises coated nanoparticles of Ag, Au, Cu, Ni, Pd, Fe or alloys thereof, and which in this way can contribute to a reduction of the sintering temperature.

Another possibility is offered by US 2009 0230 172 A1. In this case, a semiconductor component is fastened on a substrate by means of a sintering paste. The sintering paste may consist of a metal powder or a combination of a plurality of metal powders with a particular purity and a defined size distribution. By the use of Ag, Au, Pt or Pd powder, for example, a reduction of the required sintering temperatures can be achieved.

Furthermore, DE 10 2009 000192 A1 relates to a sintering material having structured metal particles provided with an organic coating. According to the invention, it is disclosed in this document that inorganically coated metal and/or ceramic auxiliary particles, which do not degas during the sintering process, are provided.

### SUMMARY OF THE INVENTION

It is the object of the present invention to provide a sintering composition and a sintering method for joining power electronic components, which overcome the disadvantages of the prior art and allow economical and reproducible production of mechanically and thermally stable junctions.

Surprisingly, it has been found that a liquid-phase sintering composition containing low molecular weight organic auxiliaries, at least one silver salt, silver particles and a further solid metal material, characterized in that the further solid material is present in particle form and comprises tin, has significantly improved properties in comparison with sintering compositions mentioned in relation to the prior art. In comparison with pure silver sintering compositions, which may comprise particulate silver, the use of a further particulate solid material which comprises tin means that the material costs of the sintering compound can be reduced significantly. Furthermore, the process costs can be reduced significantly since, with the use of solid material containing tin, lower processing temperatures are sufficient to produce a dense sintered connection. The melting point of tin is much lower than the melting point of silver. The solid material containing silver and the solid material containing tin can be partially melted by supplying heat and a eutectic compound can be formed by partial incorporation of the particles containing tin into the silver particle matrix. This reactive sintering step is associated with a very significant reduction of the melting temperature. In this way, melting temperature reductions to below 221° C. can be achieved. These sintering compounds furthermore have a higher electrical as well as thermal conductivity, particularly in comparison with the solder compounds mentioned in the prior art. By the sintering composition according to the invention, furthermore, a connection between components is provided which allows substantially higher working temperatures by virtue of its high melting temperature. In this way, a higher efficiency of the components can be made possible.

Further advantages over pure silver sintering compounds may furthermore result from:
the possibility that the particles present can melt locally and partially, so that a liquid-phase sintering process is available. This can reduce the process temperature and provide high structural densities even with relatively low sintering pressures. Optionally, this composition may also be sintered without pressure, which leads to lower equipment outlay.
in comparison with standard solder compounds, only an insubstantial lowering of the thermal and electrical conductivities of the sintering composition, since only a part of the silver is replaced.
the possibility of adapting the CTE mismatch, optionally also by adding further particles.
the cost reduction due to the material and process in comparison with the use of pure silver sintering compounds.

A liquid-phase sintering composition in the sense of this invention is a composition which comprises solid metal particles that partially melt in the scope of a sintering process, under the effect of temperature and optionally pressure. The use of different solid metal materials can lead to the formation of mixed phases which have a lower melting temperature. Owing to the liquid metal phase, the formation of a particularly intimate junction between different components can furthermore take place in the sintering process. In this way, particularly dense and mechanically/thermally stable connections between the components can be obtained.

The sintering composition may contain low molecular weight organic auxiliaries. The organic auxiliaries may in this case be present both as liquid, in the form of organic solvents, or as solid, for example as coating material for the particulate solid material. The liquid organic solvent may in this case contribute to holding the compound together in the form of a paste or to better flow of the composition in the scope of the sintering process. Furthermore, these media can improve the adhesion of the composition to the components. Further low molecular weight organic compounds may, for example, be used in the form of low molecular weight organic compounds as coating material. Fatty acids may be mentioned in this regard by way of example. In further possible configurations of these auxiliaries are mentioned, for example, in DE 10 2010 042 702 A1 and DE 10 2010 042 721 A1. Organic compounds whose molecular weight is less than or equal to 1000 g/mol are regarded as particularly low molecular weight in the sense of this invention.

Silver salts in the sense of the invention are ionic compounds which contain silver in cationic form. Possible silver salts that may be used are compounds having anions from the group of carbonates, oxides, hydroxides, or organic anions.

Silver particles are, in particular, particles which differ from a surrounding medium by a solid phase interface. The particles comprise metallic silver and are optionally provided with a coating layer. The particles preferably have a size greater than or equal to 0.01 μm and less than or equal to 1000 μm. The geometry of the silver particles may be spherical, asymmetrical, platelet-shaped or entirely irregular. The core of the silver particles, without taking any surface coating into account, preferably consists of elemental silver.

A solid metal material in the sense of the invention is a material which essentially comprises a particulate material present not as a salt. The solid material may internally comprise a void fraction less than or equal to 5 vol %, and may optionally be coated on the surface with further metal or nonmetal constituents.

Particulate solid material comprising tin corresponds to the definition of a solid material in the sense mentioned above, with the proviso that the solid metal material is present in the form of particles and comprises tin in elemental form or in the form of an alloy. The proportion by weight of tin to the particulate solid material containing tin is variable and may be greater than or equal to 2.5 wt %, preferably greater than or equal to 5 wt %, and particularly preferably greater than or equal to 7.5 wt %. The proportions by weight of the metals in the solid body may be quantitatively determined either wet-chemically or by suitable calibration using x-ray analysis (energy dispersive x-ray spectroscopy (EDX)).

In a preferred embodiment, the particulate solid material comprising tin may be present in the liquid-phase sintering composition in spherical, asymmetrical or plate shape. These geometries of the solid material comprising tin have proven particularly suitable for obtaining a dense sintered connection. Without being restricted by theory, this may in particular result from simplified alloy formation of these particle geometries between the solid material comprising silver and the solid material comprising tin in the scope of the sintering process.

In an alternative embodiment of the liquid-phase sintering composition, the proportion of the particulate solid material comprising tin in the sintering composition may be greater than or equal to 0.1 vol % and less than or equal to 50 vol %. This proportion by volume of the solid material comprising tin in the overall sintering composition has proven particularly advantageous. In particular, with this proportion, a significant cost reduction of the sintering compound is obtained owing to the material saving and the reduction of the sintering temperature to be applied. This while substantially preserving the mechanical and thermal properties of the resulting sintered connection. Lower proportions lead to insufficient formation of a eutectic mixture, while higher proportions can too greatly reduce the thermal stability of the resulting sintered connection. The proportion by volume of the solid material comprising tin is given by the proportion by weight taking the particle density into account.

Another preferred embodiment relates to a liquid-phase sintering composition wherein the maximum dimension of the particulate solid material comprising tin is greater than or equal to 0.1 μm and less than or equal to 1000 μm. This order of magnitude of the solid material comprising tin has proven particularly advantageous for obtaining a dense sintered connection with intimate mixing of the solid material comprising tin with the silver particles. Smaller maximum dimensions can lead to mechanical instabilities, and greater maximum dimensions can lead to inhomogeneous sintered connections. The maximum dimension of the particles is in this case given by the greatest distance between two surface points of the same particle. The particulate solid material comprising tin need not necessarily be monodisperse in this case. There may also be a size distribution of the solid material comprising tin, in which case the orders of magnitude indicated above may correspond to a median particle diameter in the sense of a D₅₀ value in the case of a size distribution. The order of magnitude of the dimension of the solid material comprising tin may in this case be determined conventionally by means of an optical method (microscope) or by means of scattering methods (MALS). In order to obtain the size distribution, the results of the scattering methods may to first approximation be interpreted by means of a spherical geometry of the particles.

In another configuration of the invention, the liquid-phase sintering composition may have a composition wherein the proportion

of the organic auxiliaries is greater than or equal to 0.1 wt % and less than or equal to 10 wt %,

of the silver salts is greater than or equal to 5 wt % and less than or equal to 20 wt %,

of the silver particles is greater than or equal to 40 wt % and less than or equal to 94 wt %, and

of the particulate solid material comprising tin is greater than or equal to 0.1 wt % and less than or equal to 50 wt %,

and the sum of the individual proportions corresponds to 100 wt %. This composition of the liquid-phase sintering composition according to the invention has proven particularly advantageous in terms of process economy and method technology. The sintered connections obtained have a good mechanical strength, good thermal conductivity, long service life of the components, and lower costs in comparison with the compositions mentioned in the prior art without solid material comprising tin.

In another embodiment of the liquid-phase sintering composition, the composition may contain further metal or nonmetal particles. It is particularly expedient for the further metal or nonmetal particles to be formed in such a way that they are sintered with the solid material comprising silver and/or the solid material comprising tin during the sintering process. To this end, the further metal or nonmetal particles may for example have a sinterable surface, which may for example be produced by means of a suitable coating. Furthermore, however, it is also possible to add inert particles which are not enclosed by the sintering material and do not experience direct bonding to the solid metal material. It is also possible to select the further metal or nonmetal particles in such a way that they diffuse into the solid material comprising tin. This can positively influence the structure and density of the sintered connection. For example, ceramic particles such as in particular aluminum oxide (optionally doped), aluminum nitride, beryllium oxide, silicon oxide and silicon nitride may be used as nonmetal particles. So as not to degrade the electrical conductivity too much by adding the nonmetal particles, electrically conductive ceramics, for example boron carbide or silicon carbide, make also be used. Metal particles may, for example, be selected from the group consisting of silver, copper, gold, platinum, palladium particles or a mixture of the aforementioned particles. These further metal particles may, for example, be used in order to adapt the CTE mismatch or to produce particular structural densities of the sintered junction. The proportion by weight of the further metal or nonmetal particles may be from greater than or equal to 0.1 wt % to less than or equal to 10 wt %, preferably from greater than or equal to 0.5 wt % to less than or equal to 5 wt %, and especially preferably from greater than or equal to 0.5 wt % to less than or equal to 2.5 wt %

In another configuration according to the invention, the particulate solid material comprising tin may be present in the liquid-phase sintering composition in the form of a tin-containing alloy or mixed phase. In order to adapt the melting and alloying behavior of the tin, the solid material comprising tin may have further metal constituents. These further metal constituents are in this case preferably not spatially separated, but present in the form of mixed phases or alloys within the particle. In this way, in particular, the melting behavior of the particles comprising tin and the further alloy formation with the solid silver material can be influenced in terms of method technology. Furthermore, the mechanical hardness of the solid material comprising tin can be adapted in this way.

In a preferred embodiment, the particulate solid material comprising tin in the liquid-phase sintering composition may additionally contain copper. Copper as a further constituent of the solid material comprising tin may be particularly preferred since copper/tin alloys can lead to a reduction of the CTE in comparison with pure tin. For example, the CTE of bronze is approximately 17 E-6 1/K, while Ag has a CTE of 19 E-6 1/K and Sn has a CTE of 23 E-6 1/K. The CTE can thus be adapted to the respective present joining situation by adding copper.

Furthermore, in an additional configuration, the proportion of copper in the particulate solid material comprising tin in the liquid-phase sintering composition is greater than or equal to 85 mol % and less than or equal to 95 mol %. This tin-bronze solid material together with the silver particles can lead to both a significant reduction of the material costs and dense sintered layers in comparison with the solid materials mentioned in the prior art. Precisely the favorable alloy formation of the tin bronze with the silver particles can contribute to rapid method management with low sintering temperatures. Furthermore, sintering compounds of this type have an only insubstantially inferior thermal conductivity in comparison with sintering compounds having pure silver particles.

In another alternative embodiment of the liquid-phase sintering composition, the solid material comprising tin may consist of tin. In order to obtain solid particles with a melting point as low as possible, the solid material comprising tin may consist entirely of tin. This means that the proportion of tin in the solid particle may be greater than or equal to 98 wt %. This proportion of tin in the solid particle can facilitate the method management by allowing the use of lower process temperatures. There may also be a positive effect on the sintering time.

The invention furthermore relates to a method for the material-fit joining of electronic components, comprising the method steps

a) preparing two components with surfaces to be joined,

b) introducing a liquid-phase sintering composition between at least a part of the surfaces of the components to be joined from step a),

c) sintering the liquid-phase sintering composition,

characterized in that the liquid-phase sintering composition in step b) contains particulate solid material comprising tin.

In respect of the method for the material-fit joining of electronic components, there are two different application cases. On the one hand, two electronic components may be joined directly to or onto one another, or one or more components may be joined onto a carrier. The electrically conductive connection of the individual electronic components may then take place via the carrier. Accordingly, carriers also constitute electronic components in the sense of step a). The surfaces of the electronic components are preferably made of metal. The electronic components may in this case belong to the classes of electronic components which are standardly used in the field of power electronics, consumer electronics and similar fields. In particular, these include carrier materials and baseplates such as equipped circuit carriers, housings, DCB, AMB, IMS, PCB, LTCC and standard ceramic substrates and leadframes.

In step b) depending on the viscosity of the liquid-phase sintering composition, the sintering composition may be applied fully or only partially onto one or both surfaces of the components. This, for example, by brushing, scattering, spraying, doctor blading, printing or application in the form of a sheet, a wire or a plate. The two components are in this case either already positioned beforehand at the desired distance from one another, or this distance is subsequently adjusted mechanically after application of the liquid-phase sintering composition.

In step c), the liquid-phase sintering composition is sintered by means of a heating step with or without application of static pressure. In this case, the solid particles present in the liquid-phase sintering composition are fully or partially melted, and the surfaces of the electronic components are thus joined with a material fit. The method may be carried out in a plurality of temperature steps or ramps, or at a constant temperature.

In an additional configuration of the method for the material-fit joining of electronic components, the solid material comprising tin of the sintering composition in step b) may consist of tin or bronze. Tin and bronze solid materials are particularly suitable for use in the joining method according to the invention because of their properties of entering a melting point-lowering mixed phase with silver. By the use of tin, or the tin/copper alloy, mechanically and thermally very stable sintered layers can be obtained. Furthermore, the melting points of the compounds allow economical process management with the use of only low sintering temperatures. The solid material consisting of tin or bronze may optionally be provided with a further metal or nonmetal surface coating.

According to another configuration of the method according to the invention for the material-fit joining of electronic components, the temperature during the sintering of the liquid-phase sintering composition in step c) may be greater than or equal to 200° C. and less than or equal to 500° C. These low sintering temperatures can suffice to provide a sufficient junction quality of the electronic components by the sintering process owing to the use of solid material comprising tin. Preferably, the temperature during the sintering of the liquid-phase sintering composition in step c) is greater than or equal to 200° C. and less than or equal to 400° C., furthermore preferably greater than or equal to 230° C. and less than or equal to 350° C.

In another configuration of the method according to the invention for the material-fit joining of electronic components, a joining pressure greater than or equal to 0.1 MPa and less than or equal to 150 MPa may additionally be applied in step c) to the parts to be joined. Preferably, the process pressure may be at most 150 MPa, preferably less than 100 MPa, more preferably less than 50 MPa. In another preferred embodiment of the invention, the joining method may be carried out entirely without pressure. This can contribute to a significant cost reduction of the method since elaborate hydraulic devices for achieving an otherwise required application pressure are not necessary.

The proposed embodiments of the method according to the invention may furthermore be used for joining power electronic components. Examples of fields of use are the joining of electronic components for: power output stages of electrical power-assisted steering, power output stages of universal inverter units, control electronics, particular at the starter and/or generator, press-fit diodes on generator shields, high-temperature-stable semiconductors such as silicon carbide, or sensors which are operated at high temperatures and require evaluation electronics close to the sensor. Use for semiconductor diodes and modules for inverters, particularly in photovoltaic systems, is also possible.

1. A liquid-phase sintering composition containing low molecular weight organic auxiliaries, at least one silver salt, silver particles and a further solid metal material, characterized in that the further solid material is present in particle form and comprises tin.

2. The liquid-phase sintering composition as claimed in claim 1, wherein the particulate solid material comprising tin is present in spherical, spattered or plate shape.

3. The liquid-phase sintering composition as claimed in claim 1, wherein the proportion of the particulate solid material comprising tin in the sintering composition is greater than or equal to 0.1 vol % and less than or equal to 50 vol %.

4. The liquid-phase sintering composition as claimed in claim 1, wherein the maximum dimension of the particulate solid material comprising tin is greater than or equal to 0.1 μm and less than or equal to 1000 μm.

5. The liquid-phase sintering composition as claimed in claim 1, wherein the proportion
of the organic auxiliaries is greater than or equal to 0.1 wt % and less than or equal to 10 wt %,
of the silver salts is greater than or equal to 5 wt % and less than or equal to 20 wt %,
of the silver particles is greater than or equal to 40 wt % and less than or equal to 94 wt %, and
of the particulate solid material comprising tin is greater than or equal to 0.1 wt % and less than or equal to 50 wt %,
and the sum of the individual proportions corresponds to 100 wt %.

6. The liquid-phase sintering composition as claimed in claim 1, wherein the composition contains further metal or nonmetal particles.

7. The liquid-phase sintering composition as claimed in claim 1, wherein the particulate solid material comprising tin is present in the form of a tin-containing alloy or mixed phase.

8. The liquid-phase sintering composition as claimed in claim 1, wherein the particulate solid material comprising tin additionally contains copper.

9. The liquid-phase sintering composition as claimed in claim 8, wherein the proportion of copper in the particulate solid material comprising tin is greater than or equal to 85 mol % and less than or equal to 95 mol %.

10. The liquid-phase sintering composition as claimed in claim 1, wherein the solid material comprising tin consists of tin.

11. A method for the material-fit joining of electronic components, comprising the method steps:
a) preparing two components with surfaces to be joined,
b) introducing a liquid-phase sintering composition between at least a part of the surfaces of the components to be joined from step a), and
c) sintering the liquid-phase sintering composition,
characterized in that the liquid-phase sintering composition in step b) contains particulate solid material comprising tin.

12. The method for the material-fit joining of electronic components as claimed in claim 11, wherein the solid material comprising tin of the sintering composition in step b) consists of tin or bronze.

13. The method for the material-fit joining of electronic components as claimed in claim 11, wherein the temperature during the sintering of the liquid-phase sintering composition in step c) is greater than or equal to 200° C. and less than or equal to 500° C.

14. The method for the material-fit joining of electronic components as claimed in claim 11, wherein a joining pressure greater than or equal to 0.1 MPa and less than or equal to 150 MPa is additionally applied in step c) to the parts to be joined.

15. (canceled)

16. The liquid-phase sintering composition as claimed in claim 2, wherein the proportion of the particulate solid material comprising tin in the sintering composition is greater than or equal to 0.1 vol % and less than or equal to 50 vol %.

17. The liquid-phase sintering composition as claimed in claim 16, wherein the maximum dimension of the particulate solid material comprising tin is greater than or equal to 0.1 μm and less than or equal to 1000 μm.

18. The liquid-phase sintering composition as claimed in claim 17, wherein the proportion
of the organic auxiliaries is greater than or equal to 0.1 wt % and less than or equal to 10 wt %,
of the silver salts is greater than or equal to 5 wt % and less than or equal to 20 wt %,
of the silver particles is greater than or equal to 40 wt % and less than or equal to 94 wt %, and
of the particulate solid material comprising tin is greater than or equal to 0.1 wt % and less than or equal to 50 wt %,
and the sum of the individual proportions corresponds to 100 wt %.

19. The liquid-phase sintering composition as claimed in claim 18, wherein the composition contains further metal or nonmetal particles.

20. The liquid-phase sintering composition as claimed in claim 19, wherein the particulate solid material comprising tin is present in the form of a tin-containing alloy or mixed phase.

21. The liquid-phase sintering composition as claimed in claim 20, wherein the particulate solid material comprising tin additionally contains copper.
